(19) United States
(12) Patent Application Publication
(10) Pub. No.: US 2006/0084028 A1
(43) Pub. Date: Apr. 20, 2006

(54) Dental curing light

(76) Inventors: Joshua James Cheetham, Windsor (AU); Raymond Maurice Cahill, Bayswater (AU); Jeffery James Cheetham, East Malvern (AU)

Correspondence Address: LAW OFFICES OF WILLIAM H. HOLT, 12311 Harbor Drive, Woodbridge, VA, 22192, US

(21) Appl. No.: 11/249,320

(22) Filed: Oct. 14, 2005

(30) Foreign Application Priority Data
Oct. 15, 2004 (AU) 2004905952

(51) Int. Cl. A61C 1/00

(52) U.S. Cl. 433/29

(57) ABSTRACT

A dental curing light 10 has a removable attachment 11 containing a source of illumination 30. The attachment 11 is axially rotatable and means is provided for supplying electrical power to the source of illumination 30 in the attachment 11.

### FIELD OF THE INVENTION

The present invention relates to a dental curing light

### SUMMARY OF THE INVENTION

In accordance with one aspect of the present invention there is provided a dental curing light comprising a removable attachment which has an outer end containing a source of illumination, the attachment being arranged to be axially rotatable in use and means being provided for supplying electrical power to the source of illumination

### DESCRIPTION OF THE DRAWINGS

The present invention will now be described, by way of example, with reference to the accompanying drawings, in which:—

FIG. 1 is a longitudinal sectional view of a dental curing light attachment of the present invention;

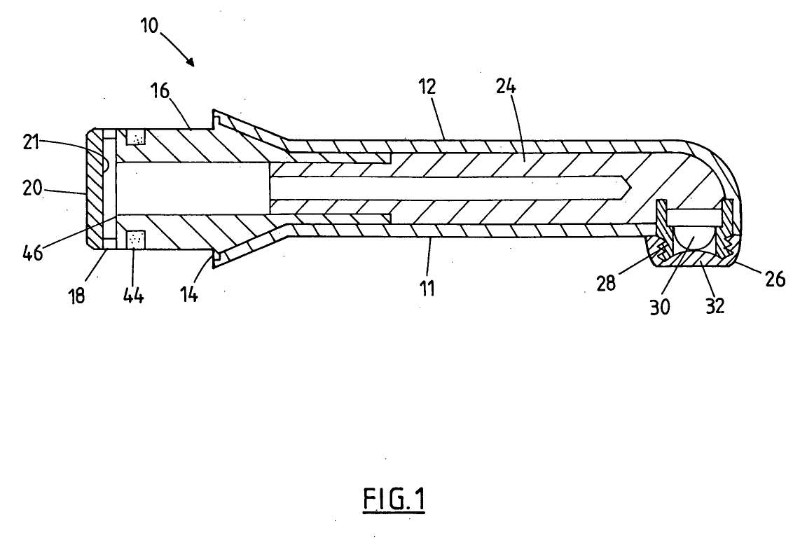

FIG. 2 is a perspective view of the attachment of FIG. 1 and a portion of a dental curing light with which the attachment is arranged to be engaged;

FIG. 3 is a longitudinal sectional view showing the attachment engaged with the portion;

FIG. 4 is a side elevation of the attachment and portion engaged with one another; and

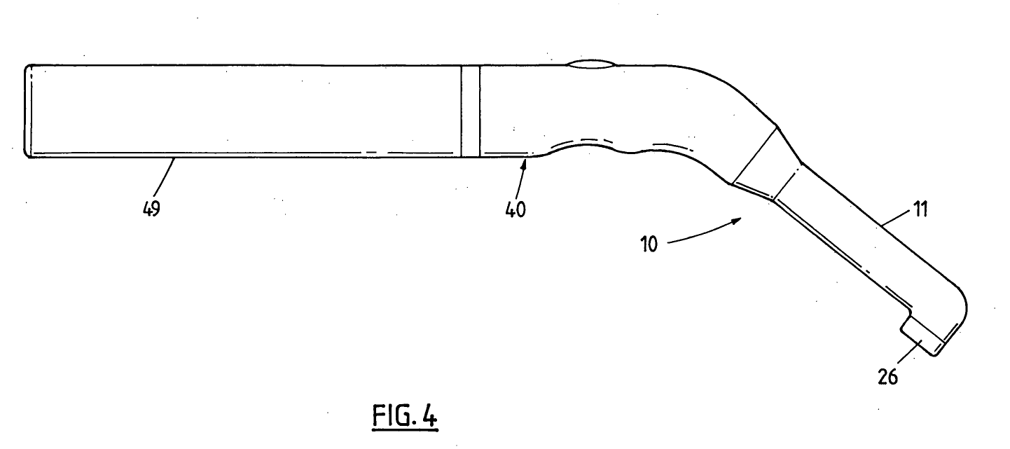

FIG. 5 is a longitudinal section of the attachment and portion engaged with one another showing the attachment rotated through 180° from the position shown in FIG. 4.

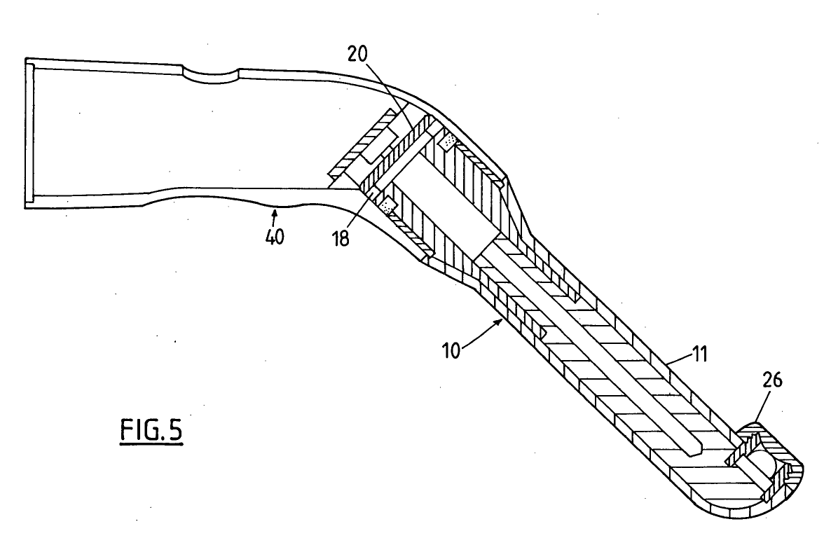

### DETAILED DESCRIPTION OF THE INVENTION

In the drawings, there is shown a dental curing light 10 having an attachment 11 which is arranged to provide a source of light for application to a surface of a dental composition to be illuminated so as to cure the dental composition or be used in a dental procedure such as bleaching.

The dental curing light attachment 11 has a housing 12 having a first open end 14. An insert 16 is mounted in the open end 14. The insert 16 has an end 18 which is provided with a connection board 20 having a rear side 21.

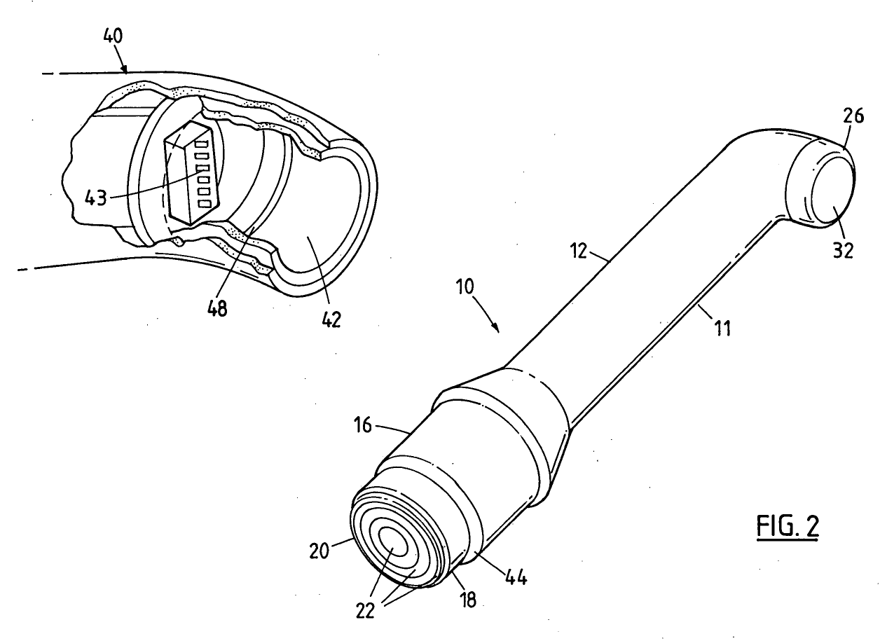

As shown in FIG. 2 the connection board 20 is provided with a plurality of circular electrical circuit rings 22 on an outer face thereof. The rings 22 are mounted about a central longitudinal rotational axis of the board 20.

As shown, the board 20 may be circular but it may have other shapes such as being square.

The housing 12 may be formed of a mouldable plastics material but it could also be made of metal or ceramic material.

The housing 12 also contains a heat sink element 24 which is arranged to remove excess heat from an LED light source 30 towards the insert 16.

The housing 12 also has a closed second end 26 remote from the end 14 in which is mounted an LED holder 28 arranged to hold in position the LED light source 30 which is disposed at an angle to the main portion of the housing 12 such as a right angle. Further, the LED light source 30 is covered by a protective element 32 which may have the shape of a lens as shown.

The protective element 32 may be formed of materials which filter certain light wavelengths or a separate filter may be mounted adjacent the protective element 32 to achieve this.

The connection board 20 preferably has at least two circular circuit rings 22 and more preferably three or more circular circuit rings 22. On the rear side 21 of the connection board 20 electrical components and control elements for the LED attachment may be connected for operation of the light attachment 11.

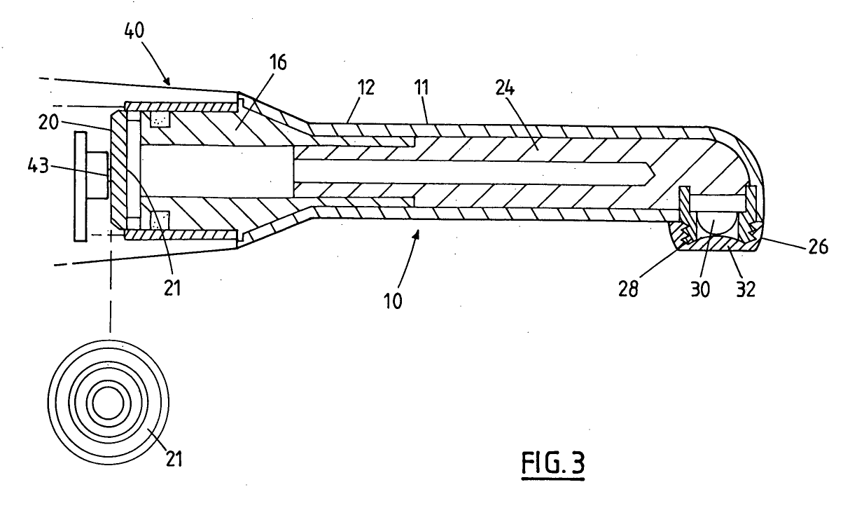

The housing 12 is arranged to be engaged with a main controlling and driving portion 40 of the light 10 which is shown in FIG. 2. The portion 40 has a receiving bush 42. The receiving bush 42 is of complementary shape and size to the insert 16 of the attachment 11. The insert 16 is arranged to be inserted into the receiving bush 42 and to be a snug fit therein as shown in FIG. 3. As shown the insert 16 is generally cylindrical, as is the internal shape of the receiving bush 42. Further, the bush 42 contains electrical contacts 43 as can best be seen in FIG. 2.

The insert 16 is arranged to be retained in the receiving bush 42 so that the attachment 11 will not fall out inadvertently when in use. Further, the insert 16 is also arranged to be completely removable from the portion 40. However, when engaged with the receiving bush 42 the attachment 11 is arranged to be axially rotatable therein.

The insert 16 may be retained in place by a number of means. For example, an O-ring 44 may extend circumferentially around the insert 16 and be located in a circumferential groove 46. Upon engagement of the insert 16 with the bush 42 the O-ring 44 engages with an internal circumferential groove 48 in the bush 42.

Other means of retaining the insert 16 in the bush 42 include a circular spring, a split ring or the like to ensure that the attachment 11 is not removed inadvertently from the portion 40 when the latter is tilted or otherwise moved.

The portion 40 can take many forms but preferably includes a removable battery/power supply 49. Electrical power may also be supplied to the portion 40 by means of a cable or other form of connection to a mains power supply.

When the attachment 11 is engaged with portion 40 the connection board 20 is in contact with the electrical contacts 43. The contacts 43 may be formed of copper or be gold plated or formed of some other electrically conducting material. Further, it is preferred that at least two contacts 43 are in contact with each circuit ring 22 on the board 20. This is to ensure that the board 20 is electrically connected to the section 40 at all times.

Alternatively, the board 20 could be mounted in the portion 40 and the contacts 43 could be mounted on the attachment 11.

In use, the attachment 11 is engaged with the portion 40 as described above. The attachment 11 when engaged may be rotated axially relative to the portion 40. The circuit rings 22 maintain electrical contact with the contacts 43 regardless of the orientation of the attachment 11. Electrical power is supplied from portion 40 to the contacts 43 and the circuit rings 22. From there power is supplied via insulated cables to the LED 30 so that, for example, a dental composition in a tooth may be illuminated and thereby cured.

As mentioned above, the board 20 preferably has at least two circular circuit rings 22 oriented around a central axis. More preferably the board 20 contains three or more circular circuit rings 22. This will allow the portion 40 of the curing light to supply power of the correct polarity to the curing light attachment 11 as well as monitoring the temperature in the curing light attachment by means of a thermocouple circuit that may be included in the heatsink 24 or other position in the curing light attachment 11. It may not be possible to perform this important function of monitoring temperature with only two circular circuit tracks. Furthermore, a third circular track may enable the portion 40 to identify which type of curing light attachment is connected to the main controlling and driving section. This may be done in a variety of ways. For example, through the use of at least one resistor and capacitor contained in the curing light attachment 11 that will enable the portion 40 to identify the different curing light attachment 11 types.

Upon insertion of the curing light attachment 11 into the portion 40, the portion 40 recognises the curing light attachment 11 type and automatically loads a curing program that may be different for each curing attachment. Programs differ in the power level supplied to the LED 30, the level of pulsing, ramp or no ramp, and the time and amount of audible tones that are heard during a cycle for a specific head. Other differences in programs are envisaged.

For example, an orthodontic appliance application procedure would preferably require a curing light attachment that exhibits an audible tone every 10 seconds, no intensity ramp up and would have to run continuously for ten minutes. Typically, in orthodontic applications the material to be photochemically cured will be exposed to a light source for 10 seconds only on the mesial surface and 10 seconds only on the distal surface. Typically, orthodontic materials are cured by a LED source that has a peak wavelength at 468 nm.

This is quite different from the application of curing a dental restorative material which requires a curing light attachment that exhibits a ramp feature and a very high intensity output LED. The higher intensity is required to obtain an ultimate penetration of light into the material and thereby achieving the highest depth of cure possible. A variety of LED light source types can be used. These may include types with different peak wavelength and distribution output. Also included are LEDs which emit light at multiple peak wavelengths (e.g. 410 and 470 nm). A collection of two or more LEDs is also envisioned in this invention.

Another type of curing light attachment is used for a bleaching procedure. In office bleaching procedures have been known for some time. Most in office bleaching materials contain pigment, dyes or other colouring agents that are able to absorb light of different wavelengths and enhance the bleaching process. Such lights can be blue, red, yellow, green or cyan in colour. Other colours can be used. A bleaching curing light attachment is generally a lower power LED, for example a 0.25 W or 1 W output to prevent the bleaching material absorbing too much radiation from the LED source thus excessively increasing the temperature of the bleach material. Curing light attachments 11, for bleaching procedures also require audible beeps every 1 minute and the light source should be able to stay on for a maximum of 1 hour. This requires extra temperature monitoring and a special program to control the LED.

Modifications and variations as would be apparent to a skilled addressee are deemed to be within the scope of the present invention

1. A dental curing light comprising a removable attachment which has an outer end containing a source of illumination, the attachment being arranged to be axially rotatable, in use, and means being provided for applying electrical power to the source of illumination.

2. A dental curing light according to claim 1, in which the attachment comprises a housing having a first end provided with a connection board, the connection board being provided with a plurality of circular electrical circuit rings on an outer face thereof.

3. A dental curing light according to claim 2, in which the connector board is provided with at least three of the circular electrical circuit rings.

4. A dental curing light according to claim 2, in which the circuit rings are mounted concentrically about a central longitudinal rotational axis of the board.

5. A dental curing light according to claim 2, in which the housing contains a heat sink element.

6. A dental curing light according to claim 2, in which the housing has a second end comprising an LED light source.

7. A dental curing light according to claim 2, comprising a main controlling and driving portion arranged to receive the attachment snugly in such manner that the received attachment is axially rotatable relative to the main controlling and driving portion.

8. A dental curing light according to claim 2, comprising a main controlling and driving portion arranged to receive the attachment snugly in such manner that the received attachment is axially rotatable relative to the main controlling and driving portion, in which the main controlling and driving portion contains electrical contacts arranged to make electrical contact with the circuit rings on the board of the attachment.

9. A dental curing light according to claim 2, comprising a main controlling and driving portion arranged to receive the attachment snugly in such manner that the received attachment is axially rotatable relative to the main controlling and driving portion, in which the main controlling and driving portion contains electrical contacts arranged to make electrical contact with the circuit rings on the board of the attachment wherein at least two contacts are in contact with each circuit ring on the board, to ensure that the board is electrically connected to the contacts at substantially all times.
